(19) United States
(12) Patent Application Publication
(10) Pub. No.: US 2026/0133293 A1
(43) Pub. Date: May 14, 2026

(54) LASER SYSTEM AND LASER MEASUREMENT METHOD

(71) Applicant: Rayz Technologies Co. Ltd., Yancheng, Jiangsu (CN)

(72) Inventors: Ruxin CHEN, Beijing (CN); Detao DU, Beijing (CN)

(21) Appl. No.: 18/834,210

(22) PCT Filed: Jan. 30, 2023
(86) PCT No.: PCT/CN2023/073759

§ 371 Date: Jul. 29, 2024

(30) Foreign Application Priority Data
Jan. 30, 2022 (CN) 202210116241.7

(51) Int. Cl. G01S 7/481; G01S 7/484; G01S 17/10

(52) U.S. Cl. CPC G01S 7/4817; G01S 7/484; G01S 17/10

(57) ABSTRACT

A laser system and a laser measurement method are provided. The laser system includes: a body assembly, for generating a scan control signal and an emission signal, and emitting groups of emitted light according to the emission signal;

and a probe assembly disposed separately from the body assembly, and optically or electrically connected to the body assembly; where the probe assembly is configured to sequentially irradiate the groups of the emitted light to at least one target object in a target scene according to the scan control signal, and convert at least one group of reflected light reflected by the at least one target object into an output signal; and the body assembly is configured to determine at least one of a distance of the target object, a reflectivity of the target object, or a contour of the target object based on the emission signal and/or the output signal.

### CROSS-REFERENCE TO RELATED APPLICATIONS

This disclosure is a national stage of International Application No. PCT/CN2023/073759, filed on Jan. 30, 2023, which claims the priority and the benefit of Chinese Patent Application No. 202210116241.7, filed on Jan. 30, 2022 with the State Intellectual Property Office of China (CNIPA). Both of the aforementioned applications are incorporated herein by reference in their entireties.

### TECHNICAL FIELD

The present disclosure relates to the field of radar technology, and more particularly, to a laser system and a laser measurement method.

### BACKGROUND

Radar is an electronic device that uses electromagnetic waves to detect target objects. Radar emits electromagnetic waves to target objects and receives their echoes, and after processing, it can obtain information such as distance, orientation and height of the target objects to the emission point where the electromagnetic waves are emitted. A laser-based radar is called a laser radar.

With the integration of technology into life, in daily life, there is a need for arranging a radar at many small items, such as blind glasses, AR glasses, or junctions of side doors and rearview mirrors of vehicles. The radar in the related art has a large overall volume and cannot be mounted on a small-volume object.

### SUMMARY

The present disclosure relates to a laser system and a laser measurement method.

According to an embodiment of the present disclosure, a laser system may include:
a body assembly for generating a scan control signal and an emission signal, and emitting multiple groups of emitted light according to the emission signal; where the emission signal includes time information indicating an emission start moment of each group of the emitted light; and
at least one probe assembly disposed separately from the body assembly, and optically or electrically connected to the body assembly;
where the probe assembly is configured to sequentially irradiate multiple groups of the emitted light into at least one target object in a target scene according to the scan control signal, and convert at least one group of reflected light reflected by the at least one target object into an output signal; where a type of the output signal is an optical signal or an electrical signal; and
the body assembly is configured to determine at least one of a distance of the target object, a reflectivity of the target object, and a contour of the target object based on the emission signal and/or the output signal.

According to an embodiment of the present disclosure, a laser measurement method may include:
generating a scan control signal and an emission signal by the body assembly and emitting multiple groups of emitted light according to the emission signal; where the emission signal includes time information indicating an emission start moment of each group of the emitted light;
sequentially irradiating multiple groups of the emitted light to at least one target object in a target scene by the probe assembly according to the scan control signal, and converting the at least one group of reflected light reflected by the at least one target object into an output signal; where a type of the output signal is an optical signal or an electrical signal; and
determining at least one of a distance of the target object, a reflectivity of the target object, and a contour of the target object according to the emission signal and/or the output signal by the body assembly.

In the present disclosure, by arranging the probe assembly and the body assembly separately and electrically connecting the probe assembly and the body assembly, when the laser system is installed, only the probe assembly is needed to be installed in the application object or the application position without installing the entire laser system in the application object or the application position, so that the applicable range of the laser system can be expanded. Furthermore, since the emission of the emitted light to the target object and the reception of the reflected light of the target object are both completed by the probe assembly, and the probe assembly is mounted at the application object or application position, it can be ensured that the detection range of the entire laser system is not affected.

Those skilled in the art will understand that the above summary content is only illustrative and is not intended to be limited in any way. In addition to the explanatory aspects, embodiments, and features mentioned above, other aspects, embodiments, and features will become apparent by referring to the accompanying drawings and the following detailed description.

### BRIEF DESCRIPTION OF THE DRAWINGS

Other features, objects, and advantages of the present disclosure will become more apparent upon reading the following detailed description of non-limiting embodiments with reference to the accompanying drawings:

FIG. 1 is block diagram I of a laser system according to an embodiment of the present disclosure;

FIG. 2 is block diagram II of a laser system according to an embodiment of the present disclosure;

FIG. 3 is block diagram III of a laser system according to an embodiment of the present disclosure;

FIG. 4 is block diagram IV of a laser system according to an embodiment of the present disclosure;

FIG. 5 is schematic diagram I of a light scanning assembly according to an embodiment of the present disclosure;

FIG. 6 is schematic diagram II of a light scanning assembly according to an embodiment of the present disclosure;

FIG. 7 is schematic diagram III of a light scanning assembly according to an embodiment of the present disclosure;

FIG. 8 is a schematic diagram of an operation principle of a probe assembly according to an embodiment of the present disclosure;

FIG. 9 is a schematic diagram of an operation principle of a photoelectric conversion assembly according to an embodiment of the present disclosure;

FIG. 10 is flow chart I of a laser measurement method according to an embodiment of the present disclosure;

FIG. 11 is flow chart II of a laser measurement method according to an embodiment of the present disclosure.

### DETAILED DESCRIPTION OF EMBODIMENTS

For a better understanding of the present disclosure, various aspects of the disclosure will be described in more detail with reference to the accompanying drawings. It is to be understood that these detailed descriptions are merely illustrative of exemplary embodiments of the disclosure, and are not intended to limit the scope of the disclosure in any way. For ease of description, only some, but not all, structures related to the present invention are shown in the drawings.

Unless defined otherwise, all terms, including engineering and scientific terms, used herein have the same meaning as commonly understood by one of ordinary skill in the art to which this disclosure belongs. It is also to be understood that unless explicitly stated in the present disclosure, terms such as those defined in commonly used dictionaries should be interpreted as having a meaning consistent with their meaning in the context of the related art, and should not be interpreted in an idealized or overly formal sense.

It should be noted that the embodiments in the present disclosure and the features in the embodiments may be combined with each other without conflict. In addition, unless explicitly defined or contradicted with context, the specific steps included in the methods recited in the present disclosure are not necessarily limited to the order recited, but may be performed in any order or in parallel. The present disclosure will now be described in detail with reference to the accompanying drawings, taken in conjunction with the accompanying embodiments.

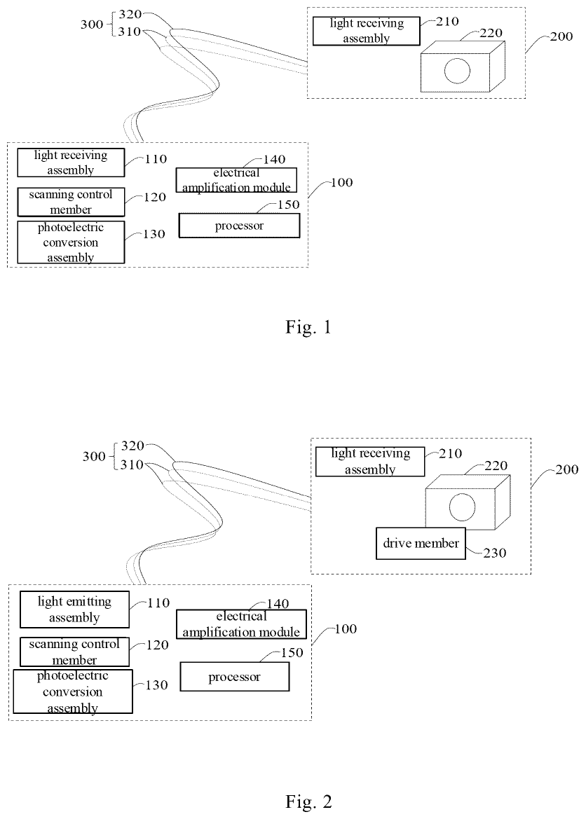

As shown in FIGS. 1-8, an embodiment of the present disclosure provides a laser system including a body assembly 100 and at least one probe assembly 200 disposed separately from the body assembly 100, the probe assembly 200 being optically or electrically connected to the body assembly 100, the body assembly 100 generating a scan control signal and an emission signal, and emitting multiple groups of emitted light according to the emission signal. The emission signal includes time information indicating an emission start moment of each group of the emitted light. The probe assembly 200 is configured to sequentially irradiate multiple groups of emitted light to at least one target object 500 in the target scene 400 according to the scan control signal, and convert at least one group of reflected light reflected by the at least one target object 500 into an output signal, the output signal being of an optical signal or an electrical signal. The body assembly 100 is configured to determine at least one of a distance of the target object 500, a reflectivity of the target object 500, or a contour of the target object 500 based on the emission signal and/or the output signal.

Since the probe assembly 200 and the body assembly 100 are disposed separately from each other in the embodiment of the disclosure, and are optically or electrically connected, the probe assembly 200 and the body assembly 100 can be fixedly mounted separately, and the probe assembly 200 may be mounted on a small-volume application object or application position compared to the entire laser system. In the case where the object of the application is a blind eyeglass, the probe assembly 200 may be fixed to a frame of the blind eyeglass, and the body assembly 100 is clamped at a waist of a user or placed in a garment pocket of the user. The probe assembly 200 may be fixed to the rearview mirror of the vehicle, and the body assembly 100 may be fixed to the ceiling of the vehicle. Thus, in operation of the laser system, the body assembly 100 generates a scanning control signal and an emission signal, and the body assembly 100 transmits the emitted light emitted from the emission signal to the probe assembly 200, and the probe assembly 200 irradiates the emitted light to at least one target object 500 in the target scene 400 according to the scanning control signal, and at least one group of reflected light formed by reflecting the emitted light at the at least one target object 500 is received and converted into an output signal by the probe assembly 200, and the output signal is transmitted to the body assembly 100, and the body assembly 100 may determine at least one of a distance of the target object 500, a reflectivity of the target object 500, and a contour of the target object 500 according to the output signal and/or the emission signal. It can be seen that the embodiments of the present disclosure extend the scope of application of the laser system by arranging the probe assembly 200 and the body assembly 100 separately and optically or electrically connecting the probe assembly 200 to the body assembly 100, so that the laser system can be installed only by installing the probe assembly 200 at the application object or application position without installing the entire laser system at the application object or application position. Furthermore, since the emission of the emitted light to the target object 500 and the reception of the reflected light of the target object 500 are both completed by the probe assembly 200, and the probe assembly 200 is installed at the application object or application position, it can be ensured that the detection range of the entire laser system is not affected.

It should be noted that the body assembly 100 and the probe assembly 200 may be electrically or optically connected via a flexible cable 300 that can conduct both current and light beams. For example, the flexible cable 300 includes an optical fiber 320 and a conductor 310. Since the length of the flexible cable 300 directly determines the farthest distance between the probe assembly 200 and the body assembly 100, flexible cable 300 of a corresponding length can be selected in accordance with discrimination of the requirements of the distance in the actual application. Of course, the body assembly 100 and the probe assembly 200 may also be electrically connected via other optical elements and wireless communication elements by spatially transmitting electrical signals and optical signals.

In the case where there are multiple probe assemblies 200, the multiple probe assemblies 200 may respectively irradiate corresponding emitted light to the target objects 500 in different target scenes 400.

Further, the type of the output signal is determined by the specific structure of the probe assembly 200, that is, different types of output signals correspond to different structures of the probe assembly 200, for example:
Form 1: If the output signal is a first optical signal, as shown in FIG. 1, the probe assembly 200 includes a light receiving assembly 210 and a light scanning assembly 220. The light scanning assembly 220 deflects the emitted light emitted by the body assembly 100, to be irradiated to the at least one target object 500 according to the scanning control signal, and/or deflects the at least one group of reflected light reflected by the at least one target object 500, to be irradiated to the light receiving assembly 210. The light receiving assembly 210 converts the reflected light into the first optical signal.

In this case, the body assembly 100 includes a light emitting assembly 110, a scanning control member 120, a photoelectric conversion assembly 130, and a processor 150. Here, the light emitting assembly 110 generates an emission signal and emits multiple groups of emitted light according to the emission signal, the scanning control member 120 generates a scan control signal, and the photoelectric conversion assembly 130 converts the first optical signal into a first electrical signal. If the output end of the photoelectric conversion assembly 130 is electrically connected directly to the input end of the processor 150, the processor 150 may determine, directly or indirectly, at least one of a distance of the target object 500, a reflectivity of the target object 500, or a contour of the target object 500 based on the emission signal and/or the first electrical signal.

Of course, considering that the signal intensity of the first electrical signal may be weak, in order to improve the accuracy of the measurement, the output end of the photoelectric conversion assembly 130 may alternatively be electrically connected to the input end of the processor 150 through the electrical amplification module 140, which amplifies the first electrical signal into the second electrical signal. The electrical amplification module 140 includes multiple amplifiers which are electrically connected in sequence, and for amplifiers of two successive stages, the intensity of the electrical signal output from the previous-stage amplifier is smaller than that of the electrical signal output from the posterior-stage amplifier. For example, the electrical amplification module 140 includes a first-stage amplifier and a second-stage amplifier. The intensity of the electrical signal output by the first-stage amplifier is smaller than that of the electrical signal output by the second-stage amplifier, and the second-stage amplifier amplifies the electrical signal output by the first-stage amplifier. The processor 150 may determine at least one of the distance of the target object 500, the reflectivity of the target object 500, and the contour of the target object 500 directly or indirectly from the emission signal and/or the second electrical signal.

Further, when the processor 150 determines the distance of the target object 500 based on the time-of-flight method, the body assembly 100 further includes a comparator and a duration determining module, and the electrical amplification module 140 is electrically connected to the processor 150 through the comparator and the duration determining module in turn. The number of comparators may be one or more. When the number of comparators is one, the comparator is connected to the duration determination module through any one of the amplifiers, for example, the comparator is connected to the output end of the last-stage amplifier. When there are multiple comparators, all output ends of the amplifiers are connected to comparators, and a voltage value of a comparison input of each comparator is different. The comparator accesses the comparison input and is configured to compare a voltage value of the comparison input with an electrical signal output from a corresponding amplifier to determine a trigger start moment, a trigger end moment, and a pulse width. The trigger start moment and the trigger end moment are respectively a start moment and an end moment of a period that the intensity of the electrical signal output by the amplifier is higher than the voltage value of the comparison input, and the pulse width is a difference between the trigger start moment and the trigger end moment. The duration determining module is arranged in one-to-one correspondence with the comparator, and the duration determining module is configured to determine the light flight duration according to the emission start moment and the corresponding trigger start moment. Since the trigger start moment is influenced by the magnitude of the voltage value of the comparison input, the corresponding pulse width is different when the voltage value of the comparison input of the electrical signal output by the trigger amplifier is different, in order to reduce above influence, the processor first corrects the light flight duration according to the pulse width, and then determines the distance and/or the reflectivity and/or the contour of the target object 500 according to the light speed and the corrected light flight duration.

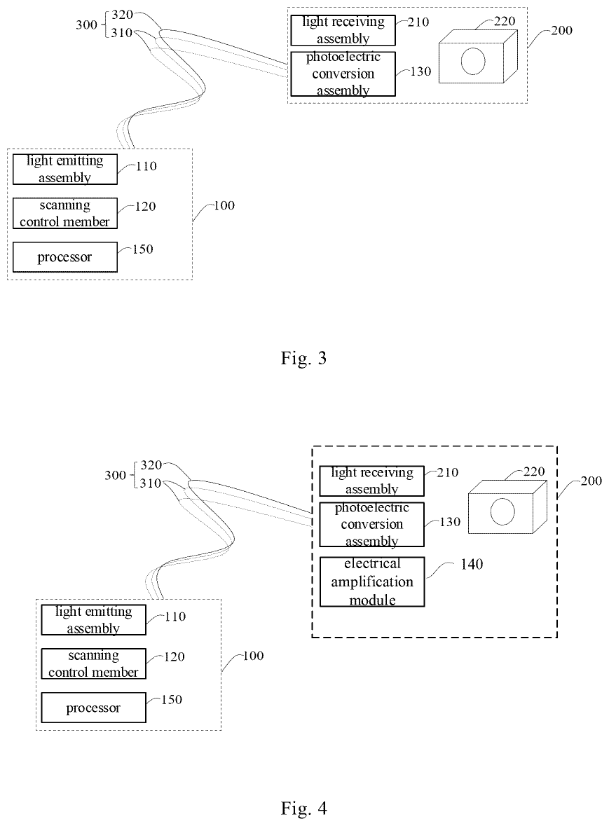

The comparison input may be a dynamic voltage curve from an external input to the comparator, or may be a dynamic voltage curve pre-stored in the comparator. Further, the duration determination module may be, but is not limited to, a TDC (full name is Time-to-Digital Converter). The duration determination module and the processor may be separate components or integrated into one component.
Form 2: If the output signal is a first electrical signal, as shown in FIG. 3, the probe assembly 200 includes a light receiving assembly 210, a light scanning assembly 220, and a photoelectric conversion assembly 130. The light scanning assembly 220 deflects the emitted light emitted by the body assembly 100, to be irradiated to the at least one target object 500 according to the scanning control signal, and/or deflects the at least one group of reflected light reflected by the at least one target object 500, to be irradiated to the light receiving assembly 210. The light receiving assembly 210 receives reflected light reflected by the target object 500 and converts the reflected light into a first optical signal, and the photoelectric conversion assembly 130 converts the first optical signal into a first electrical signal.

In this case, if the output end of the photoelectric conversion assembly 130 is directly electrically connected to the input end of the processor 150, the body assembly 100 includes the light emission assembly 110, the scanning control member 120, and the processor 150, and the processor 150 may determine at least one of the distance of the target object 500, the reflectivity of the target object 500, or the contour of the target object 500 directly or indirectly according to the emission signal and/or the first electrical signal.

If the output end of the photoelectric conversion assembly 130 is not directly electrically connected to the input end of the processor 150, in addition to the light emitting assembly 110, the scanning control member 120 and the processor 150, the body assembly 100 further includes an electrical amplification module 140, the output end of the photoelectric conversion assembly 130 is electrically connected to the input end of the processor 150 through the electrical amplification module 140, the electrical amplification module 140 amplifies the first electrical signal into the second electrical signal, and the processor 150 may determine at least one of the distance of the target object 500, the reflectivity of the target object 500, and the contour of the target object 500 directly or indirectly according to the emission signal and/or the second electrical signal.
Form 3: If the output signal is a second electrical signal, as shown in FIG. 4, the probe assembly 200 includes a light receiving assembly 210, a light scanning assembly 220, a photoelectric conversion assembly 130, and an electrical amplification module 140. In this case, the body assembly 100 includes a light emitting assembly 110, a scanning control member 120, and a processor 150, the electrical amplification module 140 of the probe assembly 200 is electrically connected to the input end of the processor 150 of the body assembly 100, and the processor 150 may directly or indirectly determine at least one of the distance of the target object 500, the reflectivity of the target object 500, or the contour of the target object 500 according to the emission signal and/or the second electrical signal. In addition, when the processor 150 determines the distance of the target object 500 based on the time-of-flight method, the body assembly 100 further includes a comparator and a duration determination module, and the electrical amplification module 140 of the probe assembly 200 is in turn electrically connected to the comparator, the duration determination module and the processor 150 of the body assembly 100.
Form 4: If the output signal is an output signal of the comparator, the probe assembly 200 includes a light receiving assembly 210, a light scanning assembly 220, a photoelectric conversion assembly 130, an electrical amplification module 140, and a comparator. In this case, the body assembly 100 includes a light emission assembly 110, a scanning control member 120, a duration determination module, and a processor 150, the output end of the comparator of the probe assembly 200 is electrically connected to the duration determination module and the processor 150 in turn, and the processor 150 determines at least one of the distance of the target object 500, the reflectivity of the target object 500, or the contour of the target object 500 according to the emission signal and/or the signal of the output end of the comparator.
Form 5: If the output signal is an output signal of the duration determination module, the probe assembly 200 includes a light receiving assembly 210, a light scanning assembly 220, a photoelectric conversion assembly 130, an electrical amplification module 140, a comparator, and a duration determination module. In this case, the body assembly 100 includes a light emission assembly 110, a scanning control member 120, and a processor 150, the duration determining module of the probe assembly 200 is electrically connected to an input of the processor 150 of the body assembly 100, and the processor 150 is configured to determine at least one of the distance of the target object 500, the reflectivity of the target object 500, or the contour of the target object 500 according to the emission signal and/or the second electrical signal.

In addition, considering that if the target object 500 is far from the probe assembly 200, a period that the emitted light emitted by the probe assembly 200 is irradiated to the target object 500 and then reflected by the target object 500 to the probe assembly 200 is a long. Similarly, if the target object 500 is close to the probe assembly 200, the period that the emitted light emitted by the probe assembly 200 is irradiated to the target object 500 and then reflected by the target object 500 to the probe assembly 200 is short. It can be seen that the duration can characterize the distance of the target object 500. That is to say, if the probe assembly 200 receives reflected light after the first preset duration from the emission start moment of the emitted light, it indicates that the target object 500 is far. Therefore, in order to expand the detection range of the laser system, as shown in FIG. 8, the light receiving assembly 210 includes at least one lens group, the lens group includes multiple receiving lenses 211 sequentially disposed along the optical path of the reflected light, the multiple receiving lenses 211 are sequentially disposed along the optical path direction of the reflected light, and the spacing between the at least two receiving lenses 211 is adjustable. The focal length of the lens group gradually increases within a first preset duration from the emission start moment of emission of the emitted light, that is, the imaging position of the lens group remains unchanged and the imaging area decreases with time, so that the field angle of the lens group decreases synchronously. Thus, the laser system can operate at a large detection field angle for the first preset duration, thereby detecting a larger scene, and then operate at a small detection field angle, thereby detecting at a further distance. The first preset duration is greater than the pulse time width of the emitted light. It should be noted that the focal length of the lens group can be achieved by adjusting the spacing between two adjacent receiving lenses 211.

In some embodiments, to achieve deflection of the emitted and/or reflected light, the light scanning assembly 220 includes at least one of a MEMS mirror 221, a rotating prism, a rotating wedge mirror, an optical phased array, a photoelectric deflection device, and a liquid crystal scanner. The liquid crystal scanner includes a liquid crystal spatial light modulator, a liquid crystal superlattice surface, a liquid crystal line array, a transmissive one-dimensional liquid crystal array, a transmissive two-dimensional liquid crystal array, or a liquid crystal display module.

The scanning dimension of the light scanning component 220 may be, but is not limited to, one or two dimensions.

Taking a one-dimensional scan as an example, the scan control signal includes a first analog voltage signal. The light scanning assembly 220 rotates in the first scanning direction in accordance with the first analog voltage signal during the current frame scanning duration, so as to sequentially deflect multiple groups of emitted light to the target object 500, and/or deflect the reflected light formed by reflecting the emitted light at the target object 500, to be irradiated to the light receiving assembly 210. For example, taking the emitted light as an example, when the first scanning direction is a horizontal direction, each group of the emitted light is deflected by the light scanning assembly 220 and then is directed in a different direction, and trajectories of multiple groups of the emitted light which are sequentially deflected by the light scanning assembly 220 and then are irradiated to the target object 500 within the current frame scanning duration, may form a horizontal sector surface. It should be noted that the first scanning direction may be, but is not limited to, a vertical direction, a horizontal direction, or an inclined direction. The included direction is between the vertical direction and the horizontal direction.

Of course, the light scanning assembly 220 may rotate in a direction other than the first scanning direction. For example, the scan control signal includes a second analog voltage signal. The light scanning assembly 220 rotates in the second scanning direction in accordance with the second analog voltage signal during the current frame scanning duration to sequentially deflect multiple groups of emitted light, to be irradiated to the target object 500, and/or to deflect the reflected light formed by reflecting the emitted light at the target object 500, to be irradiated to the light receiving assembly 210. For example, taking the emitted light as an example, when the second scanning direction is a vertical direction, each group of the emitted light is deflected by the optical scanning element to a different direction, and trajectories of multiple groups of the emitted light which are sequentially deflected by the light scanning assembly and then are irradiated to the target object 500 within the scanning duration of the frame, may form a vertical sector surface. It should be noted that the first scanning direction is different from the second scanning direction, and the second scanning direction may be, but is not limited to, a vertical direction, a horizontal direction, or an inclined direction. The included direction is between the vertical direction and the horizontal direction.

As an example of two-dimensional scanning, the scanning control signal includes a first analog voltage signal and a second analog voltage signal, and a period that the first analog voltage signal controls the light scanning component 220 is the same as a period that the second analog voltage signal controls the light scanning component 220, that is, the first analog voltage signal and the second analog voltage signal simultaneously control the light scanning component 220. The light scanning component 220 simultaneously rotates along the first scanning direction and the second scanning direction within the current frame scanning duration according to the first analog voltage signal and the second analog voltage signal so as to sequentially deflect multiple groups of emitted light, to be irradiated to the target object 500, and/or deflecting the reflected light formed by reflecting the emitted light at the target object 500, to be irradiated to the light receiving assembly 210. Taking the first scanning direction being the horizontal direction and the second scanning direction being the vertical direction as an example, the light scanning assembly rotates in the horizontal direction about a vertical axis within the current frame scanning duration, while the light scanning assembly 220 rotates in the vertical direction about a horizontal axis as a whole. Taking a group of reflected light reflected by the target object 500 as an example, when the light scanning assembly 220 simultaneously rotates with an angle α in the horizontal direction and rotates with an angle β in the vertical direction, the reflected light is deflected by (α, β) after being reflected by the light scanning assembly 220. Since the light scanning assembly 220 rotates with a different angle each time, each group of reflected light is deflected by the light scanning assembly 220 to a different direction, and trajectories of multiple groups of reflected light, which are deflected by the light scanning assembly 220 in sequence in the current frame scanning duration, and then are irradiated to the light receiving assembly 210, may form a pattern similar to a cone. That is, the first scanning direction is the x-axis and the second scanning direction is the y-axis, and the projection of each group of reflected light, which is deflected by the light scanning assembly 220 to the light receiving assembly 210, on the xy-plane has a component along the x-axis and a component along the y-axis.

The waveform parameters of the first analog voltage signal and/or the second analog voltage signal include at least one of a frequency, an amplitude or a phase.

As shown in FIG. 8, in the case where the light scanning assembly 220 includes the MEMS mirror 221, the MEMS mirror 221 is configured to rotate in the first scanning direction within the current frame scanning duration according to the first analog voltage signal and/or to rotate in the second scanning direction according to the second analog voltage signal.

Further, the light scanning assembly 220 further includes a rotating mirror 224 located on the optical path of the emitted light emitted by the MEMS mirror 221 to the target object 500, the rotating mirror 224 being configured to rotate in the third scanning direction according to the scanning control signal to reflect the emitted light reflected by the MEMS mirror 221 to the target object 500. The third scanning direction may be the same as or different from the first scanning direction or the second scanning direction. This arrangement has the advantage that since the scanning frequency of the MEMS mirror 221 is fast, the scanning frequency of the rotating mirror 224 is slow, and the cost of the rotating mirror 224 is much lower than that of the MEMS mirror 221, the receiving field angle of the light receiving assembly 210 can be expanded at a lower cost by deflecting the emitted light by the MEMS mirror 221 and the rotating mirror 224 in turn. For example, when the scanning direction of the MEMS mirror 221 is the vertical direction and the scanning direction of the rotating mirror 224 is the horizontal direction, the MEMS mirror 221 rapidly sequentially deflects multiple groups of emitted light to the rotating mirror 224, and then sequentially reflects the multiple groups of emitted light to the target object 500 at a large horizontal scanning angle, that is, the trajectories of the multiple groups of emitted light deflected by the rotating mirror 224 to the target object 500, form a fan-shaped surface with a large center angle in the horizontal plane. Thus, the light scanning assembly 220 can realize vertical high-frequency scanning+horizontal wide-angle scanning. The rotating mirror 224 may be, but is not limited to, a rotating prism or a rotating wedge mirror.

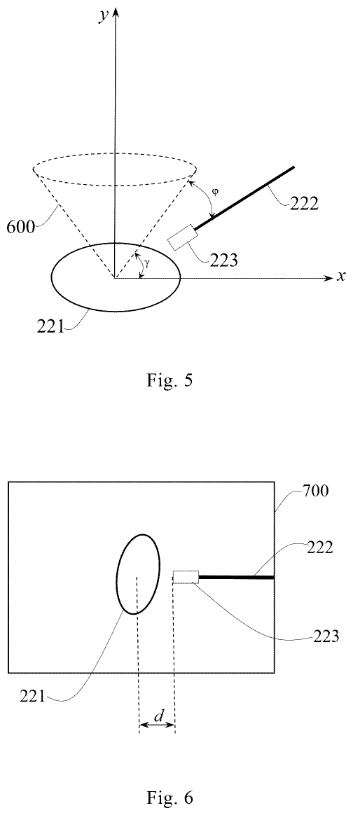

Further, as shown in FIGS. 5 to 7, in order to further reduce the volume of the probe assembly 200, the light scanning assembly 220 further includes a light guide 222 and a light collimator 223, a light inlet of the light guide 222 is connected to the body assembly 100 through a flexible cable 300, a light outlet of the light guide 222 is close to and faces the light inlet of the light collimator 223, and a light outlet of the light collimator 223 faces the reflective surface of the MEMS mirror 221. The light guide 222 may be fixed to the support member 700 for carrying the MEMS mirror 221, and the light inlet of the light guide 222 is connected to the optical fiber 320 of the flexible cable 300 by optical fiber fusion. Since the light outlet of the light guide 222 faces the light inlet of the light collimator 223, and the light outlet of the light collimator 223 faces the reflective surface of the MEMS mirror 221, multiple groups of emitted light emitted from the body assembly 100 are sequentially transmitted to the light outlet of the light guide 222 through the optical fiber 320 and then directly irradiated to the reflective surface of the MEMS mirror 221 through the light collimator 223. As shown in FIG. 5, the light path of the emitted light emitted from the light outlet of the light collimator 223 is located between the reflective surface of the MEMS mirror 221 and the specific conical surface 600, and the angle between the light path of the emitted light emitted from the light outlet of the light collimator 223 and the generatrix line of the specific conical surface 600 is smaller than a preset angle. The central axis of the specific cone surface 600 is perpendicular to the reflective surface of the MEMS mirror 221, and the vertex of the specific cone surface 600 is located on the reflective surface of the MEMS mirror 221, the included angle between the generatrix line of the specific cone surface 600 and the reflective surface of the MEMS mirror 221 is an acute angle, and the magnitude of the acute angle may be, but is not limited to, 15°˜75°. Here, the preset angle may be, but is not limited to, 0°˜45°.

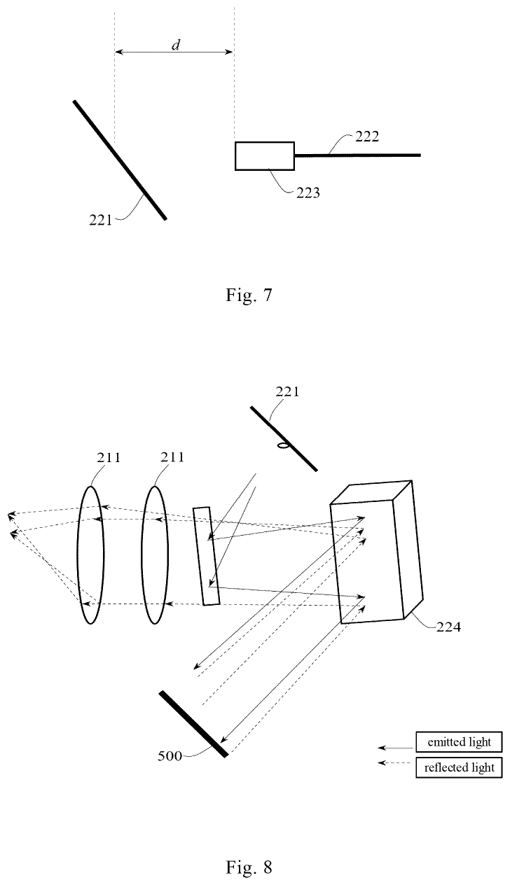

As shown in FIGS. 6 and 7, the distance d between the light outlet of the light collimator 223 and the center of the reflective surface of the MEMS mirror 221 is smaller than a preset distance, for example, the preset distance may be, but is not limited to, 0.1 cm, 1 cm, 2 cm, or 5 cm. Alternatively, in a case where the reflective surface of the MEMS mirror 221 is circular, the preset distance may be, but is not limited to, ten percent, one time, double or five times of the radius of the reflective surface of the MEMS mirror 221.

In addition, to further reduce the volume and cost of the probe assembly 200, the MEMS mirror 221, the light guide 222, and the light collimator 223 are disposed on a given chip.

As shown in FIG. 2, in order to expand the detection range of the laser system, the probe assembly 200 further includes a driving member 230 electrically connected to the body assembly 100, and the light scanning assembly 220 is disposed on the driving member 230 for driving the light scanning assembly 220 to swing or rotate according to the scanning control signal. Of course, the light receiving assembly 210 may alternatively be arranged on the driving member 230, in which case the driving member 230 can drive the light receiving assembly 210 and the light scanning assembly 220 to swing or rotate synchronously with respect to the target object 500. It should be noted that the above “rotate” generally indicates that the light scanning assembly 220 may rotate by an angle in the horizontal direction with respect to the target object 500, may rotate by an angle in the vertical direction with respect to the target object 500, or, may rotate by an angle in any spatial direction. “Swing” generally indicates repeating rotation of the light scanning assembly 220 in a certain direction. The driving member 230 may include, but is not limited to, a universal shaft and a driving motor, and the light scanning assembly 220 is arranged on the universal shaft, and the driving motor drives the universal shaft to rotate.

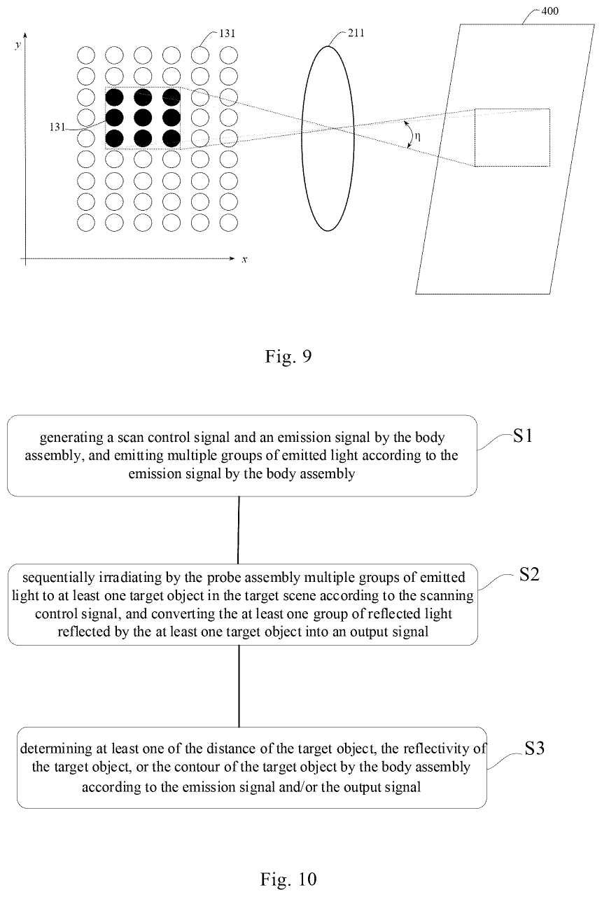

In some embodiments, as shown in FIG. 9, the photoelectric conversion assembly 130 includes multiple photoelectric conversion units 131 distributed in an array, the photoelectric conversion units 131 converting a first optical signal into a first electrical signal. The number of the photoelectric conversion units 131 in the operating state among the multiple photoelectric conversion units 131 gradually decreases within a first preset duration from the emission start moment of emission of the emitted light. The photoelectric conversion units 131 in the operating state adjoin each other, and the first preset duration is greater than the pulse time width of the emitted light. As an example, the photoelectric conversion unit 131 may be, but is not limited to, an Avalanche Photo Diode (APD) or a Single Photon Avalanche Diode (SPAD). For example, as shown in FIG. 9, the photoelectric conversion module 130 includes 6×9 photoelectric conversion units 131 distributed in a rectangular array, where the black photoelectric conversion unit 131 indicates that the photoelectric conversion unit 131 is in an operating state, that is, the photoelectric conversion unit 131 is an active photoelectric conversion unit, and the white photoelectric conversion unit 131 indicates that the photoelectric conversion unit 131 is in a shutdown state, that is, the photoelectric conversion unit 131 is an inactive photoelectric conversion unit. Since the target object 500 is located in the target scene 400 and the photoelectric conversion unit 131 has a certain area, each photoelectric conversion unit 131, through the receiving lens 211, corresponds to a certain receiving area of the target scene 400, i.e., a field angle, and the field angle of the photoelectric conversion module 130 is determined by the receiving area corresponding to the photoelectric conversion unit in the operating state i.e., the active photoelectric conversion unit 131. According to the embodiment of the present invention, by adjusting the number of the photoelectric conversion units 131 in the operating state within the first preset duration from the emission start moment of the emission of the emitted light, the detection field angle of the laser system can be changed, so that the laser system can operate at a large detection field angle within the first preset duration, thereby detecting a larger scene, and then operate at a small detection field angle, thereby detecting a further distance.

In the existing technology, to improve the resolution in a certain direction, the laser system has multiple emitting fields of view in this direction, while the same number of receiving fields of view need to be correspondingly matched with the emitting fields. In order to accurately synchronously match the emitting fields of view and the receiving fields of view, the laser system needs to be provided with a complex control system to accurately control the light scanning assembly. Therefore, in order to avoid the accurate matching between the emitting field of view and the receiving field of view, and further simplify the control method of the light scanning assembly 220, in the embodiment of the present disclosure, the emitting field of view of the optical transmission assembly 110 is located in the receiving field of view of the corresponding photoelectric conversion assembly 130 within a preset receiving duration from the emission start moment of the corresponding emitted light, and the area of the receiving field of view is not smaller than twice the area of the emitting field of view. The emitting field of view is a projection area of each group of emitted light in the target scene 400, and the receiving field of view is an area in the target scene 400 corresponding to all light beams that can be received by the photoelectric conversion assembly 130. In this case, the photoelectric conversion module 130 includes multiple photoelectric conversion units 131 disposed in sequence in the length direction and the width direction of the receiving field of view, that is, the multiple photoelectric conversion units 131 are distributed in a two-dimensional array, and the photoelectric conversion units 131 in the operating state of the multiple photoelectric conversion units 131 convert all the first optical signals into corresponding first electrical signals.

The light scanning assembly 220 is further configured to generate a current scanning angle signal when the reflected light reflected by the target object 500 is deflected and send to the processor 150 of the body assembly 100. For example, in the case where the light scanning assembly 220 includes the rotating mirror 224, a code disc is arranged on the rotating mirror 224. The code disc detects the current scan angle of the rotating mirror 224 in real time, and sends the detection result, i.e., the current scan angle signal, to the processor 150 of the body assembly 100. As another example, in the case where the light scanning assembly 220 includes the MEMS mirror 221, a torque detector is arranged on the MEMS mirror 221. The torque detector detects the torque of the MEMS mirror 221 in real time and converts the torque of the MEMS mirror 221 into a current scan angle signal and sends the current scan angle signal to the processor 150 of the body assembly 100. The processor 150 of the body assembly 100 is configured to determine an irradiation angle of the emitted light to the target object 500 based on at least one of a scan control signal, the current scan angle signal, an output signal, or a position where the first electrical signal is output on the photoelectric conversion assembly 130. For example, in the case where the photoelectric conversion module 130 includes multiple photoelectric conversion units 131, “a position where the first electrical signal is output on the photoelectric conversion assembly 130” generally refers to the position where the photoelectric conversion unit 131 outputting the first electrical signal is located.

In order to expand the application field of the laser system and enable it to be applied to fields of AR, VR and meta-universe, multiple groups of emitted light includes at least one group of first emitted light and at least one group of second emitted light, the emission moment of the first emitted light is earlier than the emission moment of the second emitted light, the reflected light of the first emitted light reflected by the corresponding target object 500 is converted into an output signal, and the second emitted light is visible light, that is, the first emitted light is used for measuring at least one of a distance, a reflectivity or a contour, and the second emitted light is used for projecting an image. The light scanning assembly 220 is configured to after irradiating the first emitted light to the multiple target objects 500, project the second emitted light to a surface of one of the multiple target objects 500 according to a preset effect according to at least one of a distance of the target object 500, an irradiation angle, a reflectivity of the target object 500, or a contour of the target object 500. Since the second emitted light is projected on the surface of the target object 500 according to at least one of the distance of the target object 500, the irradiation angle, the reflectivity of the target object 500, or the contour of the target object 500, the imaging of the second emitted light on the surface of the target object 500 can reproduce a real image.

For example, when the surface of the target object 500 is spherical, the light emitting assembly 110 emits at least one group of first emitted light to the surface of the target object 500 through the probe assembly 200, and then emits at least one second group of emitted light. The processor 150 determines at least one of a distance of the target object 500, a reflectivity of the target object 500, or a contour of the target object 500 based on the emission signal and/or the output signal corresponding to the first emitted light, and at the same time, the processor 150 determines an irradiation angle at which the emitted light is irradiated to the target object 500 based on at least one of a scan control signal, a current scan angle signal, an output signal, or a position where the photoelectric conversion assembly outputs the first electrical signal. Thereafter, the light scanning assembly 220 projects a second emitted light, such as an insect image, on the surface of the target object 500 according to at least one of the distance of the target object 500, the irradiation angle, the reflectivity of the target object 500, or the contour of the target object 500 determined by the processor 150 based on the first emitted light. Since the second emitted light is projected on the surface of the target object 500 according to at least one of the distance of the target object 500, the irradiation angle, the reflectivity of the target object 500, or the contour of the target object 500, the insect image is not distorted by the curved surface of the target object 500, but covers the curved surface of the target object 500 with a certain curvature, so that the target object 500 reproduces the real insect. The second emitted light may include, but is not limited to, at least one of red light, blue light, or green light.

For another example, when the target object 500 is a windshield or AR glasses of a vehicle, the light scanning assembly 220 first projects the first emitted light on the windshield or AR glasses of the vehicle, and then projects the preset virtual AR image, that is, the second emitted light, on the windshield or AR glasses of the vehicle according to at least one of the distance of the target object 500, the irradiation angle, the reflectivity of the target object 500, or the contour of the target object 500, so that the user can view a scene of the augmented real world and the virtual world.

Of course, the light scanning assembly 220 may directly project the first emitted light and the second emitted light onto the surfaces of two different target objects 500, respectively, in which case the laser system is equivalent to a common projection device.

In some embodiments, the body assembly 100 further includes a display component and/or a prompt component. The display component is configured to display at least one of a distance of the target object 500, an irradiation angle, a reflectivity of the target object 500, or a contour of the target object 500. The prompt component is configured to output a prompt signal according to at least one of the distance of the target object 500, the irradiation angle, the reflectivity of the target object 500, or the contour of the target object 500. The prompt component may be, but is not limited to, a microphone or a vibrator.

In some embodiments, the light emitting assembly 110 includes multiple light emitting units, and angles of emitted light generated by at least two of the multiple light emitting units relative to the light scanning assembly are different. By way of example, the light-emitting unit may include, but is not limited to, any one of a point light source, a line light source, and a plane light source. In some embodiments, the optical characteristics of the emitted or reflected light include at least one of light intensity, an AM modulation function, i.e., an amplitude modulated modulation function, an FM modulation function, i.e., a frequency modulated modulation function, an optical waveform, an optical polarization, an optical wavelength, an optical wavelength distribution, a light spot shape, or a light pulse time width.

In the case where the emitted light is a long pulse beam, in order to focus the emitted light better, the emitted angle of each group of emitted light emitted by the light emitting assembly 110 gradually decreases within a second preset duration from a corresponding emission start moment. The second preset duration is smaller than the pulse time width of the emitted light.

In some embodiments, the target object 500 is located within the target scene, and a ratio of the projection range of each group of emitted light emitted by the probe assembly 200 in the target scene to the range of the target scene is smaller than a preset ratio; Here, the preset ratio is 1:10, 1:100, 1:1000, 1:10000, or 1:100000.

As shown in FIG. 10, an embodiment of the present disclosure further provides a laser measurement method. The distance measurement method is implemented based on the laser system, and includes:
S1, generating a scan control signal and an emission signal by the body assembly 100, and emitting multiple groups of emitted light according to the emission signal by the body assembly 100; wherein the emission signal includes time information indicating the emission start moment of each group of emitted light;
S2, sequentially irradiating by the probe assembly 200 multiple groups of emitted light to at least one target object 500 in the target scene according to the scanning control signal, and converting the at least one group of reflected light reflected by the at least one target object 500 into an output signal; where the type of the output signal is an optical signal or an electrical signal; and
S3, determining at least one of the distance of the target object 500, the reflectivity of the target object 500, or the contour of the target object 500 by the body assembly 100 according to the emission signal and/or the output signal.

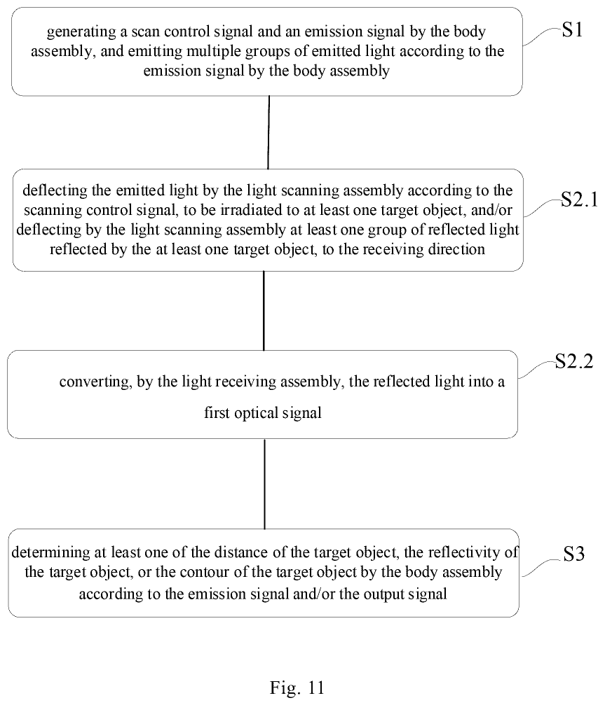

As shown in FIG. 11, in the case where the probe assembly 200 includes the light receiving assembly 210 and the light scanning assembly 220, step S2 includes:
S2.1, deflecting the emitted light by the light scanning assembly 220 according to the scanning control signal, to be irradiated to at least one target object 500, and/or deflecting by the light scanning assembly 220 at least one group of reflected light reflected by the at least one target object 500, to the receiving direction; and
S2.2, receiving, by the light receiving assembly 210, reflected light reflected by the target object 500 and converting, by the light receiving assembly 210, the reflected light into a first optical signal.

Further, the scan control signal includes a first analog voltage signal and/or a second analog voltage signal. Step S2.1 includes scanning by the light scanning assembly 220 along a first scanning direction and/or along a second scanning direction according to a first analog voltage signal within a current frame scanning duration, to sequentially deflect multiple groups of emitted light to the target object 500; and/or
scanning by the light scanning assembly 220 along the first scanning direction and/or along the second scanning direction within the current frame scanning duration according to the first analog voltage signal, to deflect the reflected light formed by reflecting the emitted light at the target object 500, to the receiving direction.

The period that the first analog voltage signal controls the light scanning assembly 220 is the same as the period that the second analog voltage signal controls the light scanning assembly 220, and the first scanning direction is different from the second scanning direction. For example, the first scanning direction is perpendicular to the second scanning direction.

In some embodiments, in step S1, emitting multiple groups of emitted light according to the emission signal by the body assembly 100 includes: emitting by the body assembly 100 the emitted light having a gradually decreasing emission angle within a second preset duration from the emission start moment; where the second preset duration is greater than the pulse time width of the emitted light.

In some embodiments, in a case where the body assembly 100 or the probe assembly 200 includes a photoelectric conversion assembly 130, the laser measurement method further includes: converting the first optical signal into the first electrical signal through the photoelectric conversion assembly 130. In the case where the output end of the photoelectric conversion module 130 is connected to the electrical amplification module 140, the distance measuring method may further include:
amplifying the first electrical signal into the second electrical signal through the electrical amplification module 140.

In some embodiments, the laser measurement method further includes: generating by the light scanning assembly 220 a current scan angle signal after deflecting the reflected light reflected by the target object 500. The irradiation angle of irradiating the emitted light to the target object 500 is determined by the body assembly 100 according to at least one of the scan control signal, the current scan angle signal, the position where the first light signal is output on the photoelectric conversion assembly 130, or the output signal.

Emitting multiple groups of emitted light according to the emission signal by the body assembly 100 in step S1 includes: emitting at least one group of first emitted light and at least one group of second emitted light by the body assembly 100. The emission moment of the first emitted light is earlier than the emission moment of the second emitted light, the reflected light formed by reflecting the first emitted light at the corresponding target object is converted into an output signal, and the second emitted light is visible light. On this basis, the laser measurement method further includes: projecting the second emitted light onto the surface of one of the multiple target objects 500 according to a preset effect based on at least one of a distance, an irradiation angle, a reflectivity, or a contour after the first emitted light is irradiated to the multiple target objects 500 by the light scanning assembly 220; or, irradiating the first emitted light and the second emitted light respectively to two different target objects 500 by the light scanning assembly 220. The previous approach enables the laser system to be applied to fields of the AR, VR and meta-universe, while the posterior approach enables the laser system to have the projection function of a common projection device.

In some embodiments, the body assembly 100 further includes a display component and/or a prompt component. The prompt component may be, but is not limited to, a microphone or a vibrator. The laser measurement method further includes: displaying at least one of a distance, a reflectivity, and a contour through a display component; and/or outputting a prompt signal according to at least one of a distance, a reflectivity, or a contour by the prompt component.

The above description is only for the embodiments disclosed herein and an explanation of the technical principles used. A person of skill in the art should understand that the scope of protection referred to in this disclosure is not limited to technical solutions formed by specific combinations of the aforementioned technical features, but also includes other technical solutions formed by arbitrary combinations of the aforementioned technical features or their equivalent features without departing from the technical concept. For example, a technical solution is formed by replacing the above features with (but not limited to) technical features with similar functions disclosed in this disclosure.

1. A laser system comprising:
a body assembly, for generating a scan control signal and an emission signal, and emitting a plurality of groups of emitted light according to the emission signal; wherein the emission signal includes time information indicating an emission start time of each group of the emitted light; and
at least one probe assembly disposed separately from the body assembly, and optically or electrically connected to the body assembly;
wherein the probe assembly is configured to sequentially irradiate the plurality of groups of the emitted light to at least one target object in a target scene according to the scan control signal, and convert at least one group of reflected light reflected by the at least one target object into an output signal; wherein a type of the output signal is an optical signal or an electrical signal; and
the body assembly is configured to determine at least one of a distance of the target object, a reflectivity of the target object, or a contour of the target object based on the emission signal and/or the output signal.

2. The laser system according to claim 1, wherein the probe assembly comprises a light receiving assembly and a light scanning assembly;
wherein the light scanning assembly deflects the emitted light emitted by the body assembly, to be irradiated to the at least one target object according to the scanning control signal, and/or deflects the at least one group of reflected light reflected by the at least one target object, to be irradiated to the light receiving assembly; and the light receiving assembly converts the reflected light into a first optical signal.

3. The laser system according to claim 2, wherein the light receiving assembly comprises at least one lens group including a plurality of receiving lenses sequentially disposed along an optical path of the reflected light, and a spacing between at least two of the receiving lenses is adjustable;
wherein a focal length of the lens group is gradually increased within a first preset duration from the emission start moment so that a field angle of the lens group is synchronously reduced; wherein the first preset duration is greater than a pulse time width of the emitted light.

4. (canceled)

5. The laser system according to claim 2, wherein the scan control signal comprises a first analog voltage signal and/or a second analog voltage signal; the light scanning assembly sequentially deflects the plurality of groups of the emitted light to the at least one target object within a current frame scanning duration according to the scanning control signal, and/or deflects at least one group of reflected light formed by reflecting the emitted light at the at least one target object, to be irradiated to the light receiving assembly;
wherein the first analog voltage signal is used to control the light scanning assembly to rotate in a first scanning direction within the current frame scanning duration; the second analog voltage signal is used to control the light scanning assembly to rotate in a second scanning direction within the current frame scanning duration; a period that the first analog voltage signal controls the light scanning assembly is the same as a period that the second analog voltage signal controls the light scanning assembly, and the first scanning direction is different from the second scanning direction.

6-7. (canceled)

8. The laser system according to claim 5, wherein the light scanning assembly comprises a MEMS mirror configured to rotate in the first scanning direction within a current frame scanning duration according to the first analog voltage signal and/or rotate in the second scanning direction according to the second analog voltage signal.

9. The laser system according to claim 8, wherein the light scanning assembly further comprises a rotating mirror located on an optical path of the emitted light reflected by the MEMS mirror to the target object, the rotating mirror being configured to rotate in a third scanning direction according to the scan control signal to reflect the emitted light reflected by the MEMS mirror to the target object.

10-11. (canceled)

12. The laser system according to claim 8, wherein the light scanning assembly further comprises a light guide and a light collimator, a light inlet of the light guide is connected to the body assembly by a cable, the light outlet of the light guide is close to and faces a light inlet of the light collimator, and the light outlet of the light collimator faces the reflective surface of the MEMS mirror,
wherein an optical path of the emitted light emitted from the light outlet of the light collimator is located between the reflective surface of the MEMS mirror and a specific conical surface, and an included angle between the optical path of the emitted light and a generatrix line of the specific conical surface is smaller than a preset angle;
wherein a central axis of the specific conical surface is perpendicular to the reflective surface of the MEMS mirror, the generatrix line of the specific conical surface is located on the reflective surface of the MEMS mirror, and the included angle between the generatrix line of the specific conical surface and the reflective surface of the MEMS mirror is an acute angle; wherein the acute angle ranges from 15°˜75 °.

13. (canceled)

14. The laser system according to claim 2, wherein the probe assembly further comprises a drive member electrically connected to the body assembly, the light scanning assembly is disposed on the drive member, and the drive member is configured to drive the light scanning assembly to swing or rotate according to the scanning control signal.

15. (canceled)

16. The laser system according to claim 2, wherein the body assembly or the probe assembly comprises: a photoelectric conversion assembly for converting the first optical signal into a first electrical signal,
wherein the light scanning assembly is further configured to generate a current scanning angle signal while deflecting the reflected light reflected by the target object; the body assembly is further configured to determine an irradiation angle of irradiating the emitted light to the target object based on at least one of the scan control signal, the current scan angle signal, the output signal, and a position where the first electrical signal is output on the photoelectric conversion assembly.

17. The laser system according to claim 16, wherein the plurality of groups of the emitted light includes at least one group of first emitted light and at least one group of second emitted light, an emission moment of the first emitted light is earlier than an emission moment of the second emitted light, the reflected light formed by reflecting the first emitted light at the corresponding target object is converted into the output signal, and the second emitted light is visible light;
wherein after the light scanning assembly irradiates the first emitted light to a plurality of target objects, the second emitted light is projected to a surface of one of the plurality of target objects according to a preset effect according to at least one of the distance, the irradiation angle, the reflectivity, and the contour; or,
the light scanning assembly irradiates the first emitted light and the second emitted light to two different target objects respectively.

18-19. (canceled)

20. The laser system according to claim 2, wherein the body assembly or the probe assembly comprises:
a photoelectric conversion assembly for converting the first optical signal into a first electrical signal;
wherein the body assembly comprises:
a light emission assembly for generating the emission signal and emitting the plurality of groups of the emitted light according to the emission signal;
a scan control component for generating the scan control signal; and
a processor for determining at least one of the distance, the reflectivity, or the contour according to the emission signal and/or the output signal,
wherein an output end of the photoelectric conversion assembly is electrically connected to the processor; or,
the output end of the photoelectric conversion assembly is electrically connected to the processor through an electrical amplification module for amplifying the first electrical signal into a second electrical signal.

21. The laser system according to claim 20, wherein the electrical amplifying module comprises a plurality of stages of amplifiers electrically connected in sequence, and for two adjacent stages of the amplifies, an intensity of an electrical signal output by a previous-stage amplifier is smaller than an intensity of an electrical signal output by a posterior-stage amplifier.

22. The laser system according to claim 21, wherein an output end of at least one stage of the amplifiers is connected to a comparator, an input end of the comparator is connected to a comparison input, and the comparison input of the comparator is in one-to-one correspondence with the amplifier; the comparator is configured to compare a voltage value of the comparison input with an electrical signal corresponding to an output of the amplifier to determine a trigger start moment, a trigger end moment, and a pulse width; wherein the trigger start moment and the trigger end moment are respectively a start moment and an end moment of a period that an intensity of the electrical signal output by the amplifier is higher than the voltage value of the comparison input, and the pulse width is a difference between the trigger end moment and the trigger start moment; an output end of each comparator is connected to a duration determining module, and the duration determining module is configured to determine a light flight duration according to the emission start moment and the corresponding trigger start moment; and the processor determines at least one of the distance, the reflectivity, and the contour based on at least one of the light flight duration, the pulse width, the intensity of the second electrical signal, or the light speed.

23. (canceled)

24. The laser system according to claim 2, wherein the body assembly or the probe assembly comprises:
a photoelectric conversion assembly for converting the first optical signal into a first electrical signal;
wherein the body assembly comprises:
a light emission assembly for generating the emission signal and emitting the plurality of groups of the emitted light according to the emission signal;
a scan control component for generating the scan control signal; and
a processor for determining at least one of the distance, the reflectivity, or the contour according to the emission signal and/or the output signal,
wherein an emitting field of view of the light emitting assembly within a preset receiving duration from an emission start moment corresponding to emission of the emitted light is located in a receiving field of view corresponding to the photoelectric conversion assembly, and an area of the receiving field of view is not smaller than twice an area of the emitting field of view; the emitting field of view is a projection area of each group of the emitted light in the target scene, and the receiving field of view is an area corresponding to all light beams that can be received by the photoelectric conversion assembly in the target scene.

25. The laser system according to claim 24, wherein the photoelectric conversion assembly includes a plurality of photoelectric conversion units disposed in sequence along a length direction and a width direction of the receiving field of view respectively, and a photoelectric conversion unit in an operating state in the plurality of photoelectric conversion units converts all the first optical signals into corresponding first electrical signals.

26. The laser system according to claim 2, wherein the body assembly or the probe assembly comprises:
a photoelectric conversion assembly for converting the first optical signal into a first electrical signal;
wherein the body assembly comprises:
a light emission assembly for generating the emission signal and emitting the plurality of groups of the emitted light according to the emission signal;
a scan control component for generating the scan control signal; and
a processor for determining at least one of the distance, the reflectivity, or the contour according to the emission signal and/or the output signal,
wherein an emission angle of each group of the emitted light emitted by the light emitting assembly gradually decreases for a second preset duration from a corresponding emission start moment; wherein the second preset duration is smaller than the pulse time width of the emitted light.

27-30. (canceled)

31. A laser measurement method based on a laser system comprising a body assembly, the method comprising:
generating a scan control signal and an emission signal by the body assembly and emitting by the body assembly a plurality of groups of emitted light according to the emission signal; wherein the emission signal comprises time information indicating an emission start moment of each group of the emitted light;
sequentially by the probe assembly irradiating the plurality of groups of the emitted light to at least one target object in a target scene according to the scan control signal, and converting at least one group of reflected light reflected by the at least one target object into an output signal; wherein a type of the output signal is an optical signal or an electrical signal; and
determining by the body assembly at least one of a distance of the target object, a reflectivity of the target object, or a contour of the target object according to the emission signal and/or the output signal.

32. The laser measurement method according to claim 31, wherein the probe assembly comprises a light receiving assembly and a light scanning assembly;
irradiating the emitted light to at least one target object in the target scene according to the scan control signal, and converting at least one group of reflected light reflected by the at least one target object into the output signal comprises:
deflecting, by the light scanning assembly, the emitted light emitted by the body assembly, to be irradiated to the at least one target object according to the scanning control signal, and/or deflecting, by the light scanning assembly, the at least one group of the reflected light reflected by the at least one target object to a receiving direction; and
converting the reflected light into a first optical signal by the light receiving assembly.

33. The laser measurement method according to claim 32, wherein the scan control signal comprises a first analog voltage signal and/or a second analog voltage signal;
deflecting, by the light scanning assembly, the emitted light emitted by the body assembly, to be irradiated to at least one target object according to the scanning control signal, and/or deflecting, by the light scanning assembly, the at least one group of the reflected light reflected by the at least one target object to the receiving direction comprises:
scanning by the light scanning assembly along a first scanning direction and/or along a second scanning direction within a current frame scanning duration according to the first analog voltage signal, so as to sequentially deflect the plurality of groups of the emitted light, to be irradiated to the at least one target object and/or deflect the at least one group of the reflected light formed by reflecting the emitted light at the at least one target object to the receiving direction;
wherein a time period that the first analog voltage signal controls the light scanning assembly is the same as a time period that the second analog voltage signal controls the light scanning assembly, and the first scanning direction is different from the second scanning direction.

34. The laser measurement method according to claim 32, wherein the body assembly or the probe assembly comprises a photoelectric conversion assembly; and
the laser measurement method further comprises converting the first optical signal into a first electrical signal by the photoelectric conversion assembly.

35. The laser measurement method according to claim 34, further comprising:
generating, by the light scanning assembly, a current scanning angle signal while deflecting the reflected light reflected by the target object; and
determining, by the body assembly, an irradiation angle at which the emitted light is irradiated to the target object according to at least one of the scan control signal, the current scan angle signal, the output signal, and a position where the photoelectric conversion assembly outputs the first electrical signal.

36. The laser measurement method according to claim 35, wherein emitting the plurality of groups of emitted light by the body assembly comprises: emitting at least one group of first emitted light and at least one group of second emitted light by the body assembly; wherein an emission moment of the first emitted light is earlier than an emission moment of the second emitted light, the reflected light reflected by the corresponding target object is converted into the output signal, and the second emitted light is visible light;
the laser measurement method further comprises:
projecting the second emitted light onto a surface of one of a plurality of target objects according to a preset effect according to at least one of the distance, the irradiation angle, the reflectivity, or the contour after the first emitted light is irradiated to the plurality of target objects by the light scanning assembly; or
irradiating the first emitted light and the second emitted light to two different target objects respectively by the light scanning assembly.

37. The laser measurement method according to claim 31, wherein emitting the plurality of groups of emitted light according to the emitted signal by the body assembly comprises:
emitting, by the body assembly, emitted light whose emission angle gradually decreases within a second preset duration from the emission start moment;
wherein the second preset duration is smaller than a pulse time width of the emitted light.

38-39. (canceled)
